(19) United States
(12) Patent Application Publication
(10) Pub. No.: US 2024/0278448 A1
(43) Pub. Date: Aug. 22, 2024

(54) SLICING MACHINE WITH BLADE CATCHING DEVICE

(71) Applicant: MULTIVAC SEPP HAGGENMÜLLER SE & CO. KG, Wolfertschwenden (DE)

(72) Inventors: Oliver MÜLLER, Steffenberg (DE); Daniel SCHNEIDER, Dautphetal (DE)

(73) Assignee: MULTIVAC SEPP HAGGENMÜLLER SE & CO. KG, Wolfertschwenden (DE)

(21) Appl. No.: 18/583,221

(22) Filed: Feb. 21, 2024

(30) Foreign Application Priority Data
Feb. 21, 2023 (DE) 102023104231.9

(51) Int. Cl. B26D 7/22; B26D 1/00

(52) U.S. Cl. CPC B26D 7/225; B26D 1/0006; B26D 2001/006; B26D 2210/02

(57) ABSTRACT

In order to prevent a rapidly rotating blade from flying away in the event of unintentional loosening, for which purpose the blade usually rotates in a protective blade housing, a catch pivot can-alternatively or additionally—be provided, which ends with its free end at such a small distance in front of an oppositely directed free end of a rotor and also extends in a direction of a blade axis of the blade 3 that a distance therebetween is less than a thickness of the blade. This prevents the blade from coming out radially through the distance between these two parts in the area of a central opening.

### CROSS-REFERENCE TO RELATED APPLICATIONS

This application claims foreign priority benefits under 35 U.S.C. § 119(a)-(d) to German patent application number DE 102023104231.9, filed Feb. 21, 2023, which is incorporated by reference in its entirety.

### TECHNICAL FIELD

The disclosure relates to slicing machines, in particular “slicers”, with which strands of a product (e.g., an only slightly compressible product) such as sausage or cheese are sliced in the food industry.

### BACKGROUND

Since these strands can be produced with a cross-section that retains its shape and dimensions well over its length, i.e. substantially constant, they are often called product caliber.

In this process, several product calibers arranged parallel to one another are usually sliced simultaneously by slicing off one slice at a time in one passage using the same rotating blade, which moves in a transverse direction to the longitudinal direction of the product calibers.

The product calibers are pushed forward by a feed conveyor of a feeding unit in the direction of the blade for the slicing unit, usually on an inclined downward feed conveyor, in order that the slices, which are already inclined when they are cut off, fall easily onto a discharge conveyor for a discharge unit, by means of which they are transported away for further processing.

Accordingly, the blade is also assembled with its blade plane at an angle and overhanging forwards, which makes it difficult to dismantle and remove the plate-shaped blade, which is up to 120 cm in diameter, weighs 20-30 kg and has an extremely sharp slicing edge around its circumference.

However, the main danger here is that the blade, which rotates at up to 1000 rpm and is usually also unbalanced—as it may be designed as a sickle blade—could come loose from the face side of the rotor, which is set in rotation by the blade drive, and then fly away with very high kinetic energy, posing a great danger to the totality of the environment.

For this reason, it is common practice to rotate the blade in a box-shaped, substantially closed, protective blade housing, from which the sickle blade can only protrude outwards once with each rotation through a narrow slot pointing towards the product and cutting frame.

This protective blade housing is designed to be stable enough to prevent a rotating blade that comes loose and flies away from penetrating its walls.

The protective blade housing has a protective blade door on the side facing away from the blade drive, which can be opened to change the blade in order to loosen the screw connection between the blade and rotor and remove the blade.

### SUMMARY

It is therefore an object according to the disclosure to provide a slicing machine, particularly a slicer, with increased safety against a blade flying off.

With regard to a slicing machine, such as a slicer, which has the following components according to the type:
a slicing unit with
a plate-shaped or bowl-shaped blade that can be driven to rotate around a blade axis,
a blade drive that drives the blade in rotation and comprises a rotor as a receptacle for the blade,
a controller for controlling moving parts of the slicing machine,
   this object is achieved by the fact that
on the one hand, the blade comprises a through-opening through its thickness, i.e. from one side of the blade to the other along the direction of the axis of rotation of the blade, the blade axis, particularly in the form of a central opening centered on the measuring axis, and
on the other hand, a catch pivot, which can be displaced between a slicing state securing the blade and a mounting state permitting the mounting of the blade and which is thinner at least in its end area than the through-opening in its diameter, is present in the protective blade housing, which in the slicing state ends with its free end at such a small distance in front of the opposite free end of the rotor, viewed in the direction of the blade axis within the through-opening, particularly the central opening, which is less than the greatest thickness of the blade.

If the blade comes loose during operation, it cannot therefore pass between the catch pivot and the rotor at right angles to the axial direction, i.e. the direction of the axis of rotation of the blade, and fly away.

If there is also a protective blade housing, which substantially surrounds the blade, the back wall of which is penetrated by the blade drive and which comprises a movable protective blade door that can be displaced between a slicing state closing the protective blade housing and an open mounting state, the catch pivot can be arranged inside the protective blade housing.

Even then, in the closed slicing state of the protective blade housing, the catch pivot can end with its free end at such a small distance in front of the opposite free end of the rotor, viewed in the direction of the blade axis within the through-opening, particularly the central opening, that it is less than the greatest thickness of the blade.

Even if a blade were to come loose unintentionally during operation and even if the blade were able to pass between the catch pivot and the rotor, the blade receptacle, at right angles to the axial direction, i.e. the direction of the axis of rotation of the blade, it would still hit the protective blade housing.

Preferably, the largest diameter of the catch pivot is smaller than the smallest diameter of the through-opening, particularly the central opening, of the blade, such that the blade can be fully threaded onto the catch pivot in the axial direction, particularly in the event of unintentional loosening.

Preferably, the rotor and the catch pivot are arranged in such a manner that they are located within the through-opening when viewed in the direction of the blade axis.

In particular, said distance is less than the thickness of the blade in the area around its through-opening, particularly the central opening.

Preferably, the catch pivot extends within the through-opening, particularly in the central opening, into the thickness area of the blade, so that the blade is already partially threaded onto the catch pivot in the axial direction even in the proper slicing state, which promotes complete threading in the event of loosening.

In a preferred embodiment, the catch pivot is fastened to the inside of the protective blade door, preferably in such a manner that after the protective blade door has been brought into the open mounting state, the catch pivot no longer stands in the way of mounting the blade.

Alternatively, the catch pivot can be detachably arranged directly on the base frame of the machine—although still inside the protective housing—or on the inside of the protective housing but away from the protective blade door.

The fastening to the protective blade door has the advantage that the catch pivot is automatically in the correct position, the slicing state, after closing the protective housing. Fastening the safety catch pivot directly to the base frame or to the protective housing but away from the protective blade door has the advantage that the protective blade door must be designed to be less stable.

In order not to hinder the rapid rotation of the blade relative to the catch pivot when it is released, the catch pivot preferably has a circumferential contour without corners. This is understood to mean that there are at least no corners that have a rounding radius of less than 1 mm, preferably less than 2 mm, preferably less than 3 mm, preferably less than 5 mm.

The circumferential contour is preferably round or elliptical.

Preferably, the catch pivot is centered on the blade axis.

However, a balancing weight often protrudes from the rotor eccentrically to the blade axis into the thickness area of the blade, often through the thickness area of the blade, in order to compensate for the imbalance of the sickle blade. In such a case, the catch pivot is particularly arranged eccentrically to the blade axis, with its free end away from the balancing weight.

The catch pivot can be asymmetrical in the side view and widen in the axial direction away from the balancing weight to such an extent that its outer circumference substantially occupies the totality of the inner circumference of the central opening of the blade, which promotes the complete threading of the blade onto the catch pivot in the event of detachment from the rotor.

For the same reason, the front free end area of the catch pivot has a conical contour that tapers towards the free end.

The rotor can also have a recess, preferably centered, in its free end, i.e. the face side at the free end, to promote threading onto the catch pivot, into which the free end of the catch pivot can protrude without contact in the slicing state.

The largest diameter of the catch pivot should be at most 40%, preferably at most 20%, particularly at most 10%, particularly at most only 5% smaller than the smallest inside diameter of the through-opening, particularly the central opening. This prevents strong impacts in the transverse direction to the blade axis on the catch pivot when the blade is released.

To ensure that the catch pivot is in the intended slicing state during slicing operation, a pivot sensor networked to the controller of the machine is preferably provided, which detects the presence of the catch pivot in the position for slicing operation.

If at all possible, the blade slot in the wall of the protective housing facing the product, through which the blade protrudes outwards with each rotation, should be shorter than the smallest transverse axis of the blade measured in the plane of the blade to ensure that the unintentionally released rotating blade cannot move out of the protective housing through this blade slot.

Such a catch pivot for the blade inside the protective blade housing can also be easily supplemented to form a mounting aid for the blade, in that—with a catch pivot arranged on the inside of the protective blade door-a blade carrier is further provided on the inside of the protective blade door, on the rear side of which, facing the assembled blade, the blade can be fastened and/or held.

Preferably, such a blade carrier will be circumferentially larger than the blade itself, in such a way that it protrudes beyond the blade in the transverse direction, preferably along its totality, thereby reducing the risk of injury to the fitter on the blade.

Preferably, such a blade carrier can be moved back and forth in the direction of the blade axis inside the protective blade housing between a position close to the rotor and a position remote from the rotor and can preferably be fixed in one or both positions, preferably from outside the protective housing.

With regard to the method for operating a slicing machine, in particular a slicer, that has a rotating blade, which is fastened to a rotor and is driven in rotation by the latter, in particular a slicing machine as described above, the following method is used to secure a detaching blade against flying off
in slicing mode, a catch pivot extending in the direction of the blade axis is arranged with its free end at such a small distance, particularly an axial distance, in front of the opposite free end of the rotor that the distance between them is less than the thickness of the blade,
wherein, in particular, the rotating blade is substantially arranged in a protective blade housing during slicing operation.

Furthermore, with the aid of the blade carrier of a mounting device for removing the—naturally stationary—blade, it is first possible—from outside the protective housing through the corresponding through-opening, if such a protective housing is present—to loosen the blade screw connections of the blade relative to the rotor and to detach the blade from the rotor, which forms the blade receptacle.

The blade can then be picked up in or on the blade carrier, which is usually done simply by dropping the blade onto the blade carrier when the blade is usually positioned at an angle in the space.

After the blade has been fastened to the blade carrier—also from outside the protective housing, if present—the protective blade door can be opened and the blade carrier and the blade fastened to it can be moved away from the rotor together with the protective blade door, otherwise separately.

Subsequently, the blade carrier with the blade can be removed from the slicing machine, particularly from the protective blade door, and removed from the protective blade housing and thus from the slicing machine and, if necessary, transported away and stored.

Conversely, the mounting of the blade with the aid of the blade carrier can be carried out in such a manner that the blade carrier with the blade fastened to it is fastened, for example, to the inside of the open protective blade door or another part of the slicing machine and is thus already inside the protective housing.

After closing the protective blade door, the fastening of the blade to the blade carrier can be released—from outside the protective housing—and the blade fastened to the blade holder.

For this purpose, the blade carrier is preferably moved into the position close to the rotor-preferably before the fastening of the blade to the blade carrier is released—in which the blade is preferably already in contact with the rotor.

Conversely, during disassembly, before loosening the blade screw connection on the rotor, the blade carrier can be moved into a position close to the rotor, in which the blade carrier is preferably in contact with the blade, and after detaching the blade from the rotor and fastening it to the blade carrier, the blade carrier can be moved together with the blade-after fastening it to the blade carrier-into a position away from the rotor and usually close to the protective blade door, where it is preferably locked.

### BRIEF DESCRIPTION OF THE DRAWINGS

Embodiments in accordance with the disclosure are described in more detail below by way of example and with reference to the following figures:

FIGS. 1a, b: show a known slicing machine in the form of a slicer according to the prior art in different perspective views, with the feed belt folded up into the slicing position,

FIG. 1c: shows the slicing machine in FIGS. 1a, b in side view with the cladding parts removed so that the various conveyor bands are easier to see, but with the feed band folded down into the loading position and the product caliber cut open except for a caliber rest,

FIG. 2a: shows a view according to FIGS. 1c and 1n an analogous viewing direction of a slicing machine according to the disclosure, but enlarged in comparison,

FIG. 2b: shows a representation enlarged again compared to FIG. 2a, but sectioned, with the same viewing direction,

FIG. 3a: shows the situation of an unintentionally loosened blade in a representation analogous to FIG. 2a,

FIG. 3b: shows the situation of an unintentionally loosened blade as seen from the bottom right of the protective blade housing in FIG. 3a,

FIG. 4a, b: show sectional views along line IV-IV in FIG. 2a of the protective blade housing at different rotational positions of the blade,

FIG. 4c: shows a sectional view along line C-C in FIG. 4a in the protective blade housing,

FIGS. 5a, b: show views analogue to FIG. 3a with an additional blade carrier in different functional positions,

FIG. 6a: shows a view analogous to FIG. 4a with an additional blade carrier, and

FIGS. 6b, c: show views analogue to FIG. 4c with the additional blade carrier in different functional positions.

### DETAILED DESCRIPTION

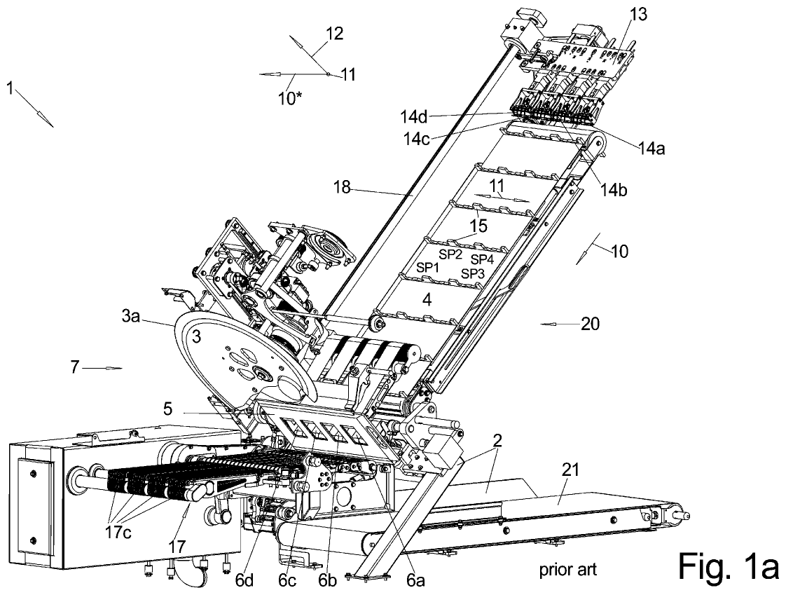

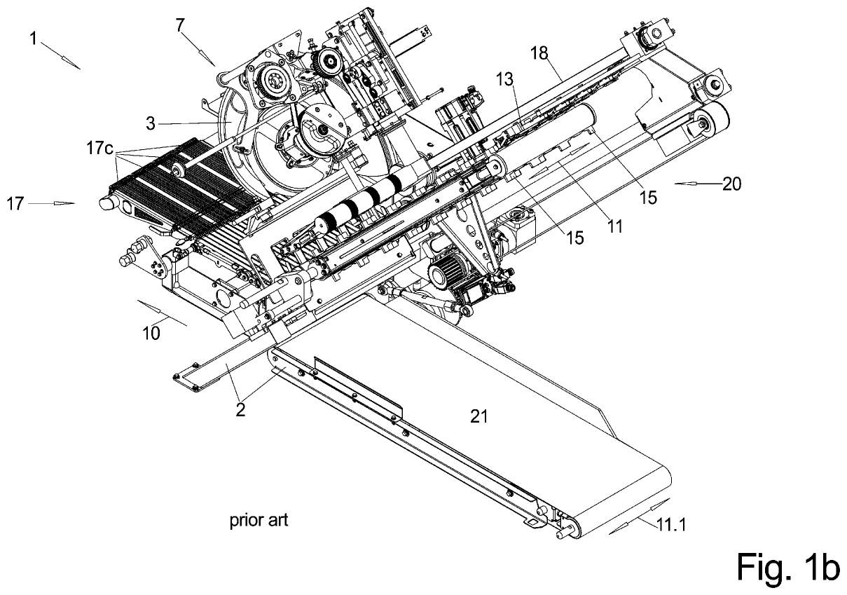

FIGS. 1a, 1b show different perspective views of a multi-track slicer 1 of the prior art for simultaneously slicing a plurality of product calibers or logs K on a respective track SP1 to SP4 next to one another and storing them in shingled portions P each consisting of a plurality of slices S with a general direction of travel 10* through the slicer 1 from right to left.

FIG. 1c shows—with caliber K inserted—a side view of a slicer 1, omitting covers, including the usual protective blade housing, and other parts, which are fastened to the base frame 2 in the same way as all other units, so that the functional parts, especially the conveyor bands, can be seen more clearly. The longitudinal direction 10 is the feed direction of the logs K to the slicing unit 7 and thus also the longitudinal direction of the logs K lying in the slicer 1.

It can be seen that the basic structure of a slicer 1 according to the prior art consists of a slicing unit 7 with a blade 3 rotating about a blade axis 3′, such as a sickle blade 3, which is fed with several, in this case four, product calibers K lying side by side on a feed conveyor 4 of a feeding unit 20 transversely to the feed direction 10 with protrusions of the feed conveyor 4 protruding from the bearing surface as spacers 15 between the product calibers K. The calibers K are fed by this feeding unit 20, and from the front ends of which the rotating blade 3 with its slicing edge 3a cuts off a slice S in each case in one operation, i.e. almost simultaneously.

For slicing the product calibers K, the feed conveyor 4 is in the slicing position shown in FIGS. 1a, b, 2a, b, which is oblique in side view with a low-lying front end on the slicing side and a high-lying rear end, from which it can be folded down about a pivot axis 4′ extending in its width direction, the first transverse direction 11, which is located in the vicinity of the slicing unit 7, into an approximately horizontal loading position as represented in FIG. 1c.

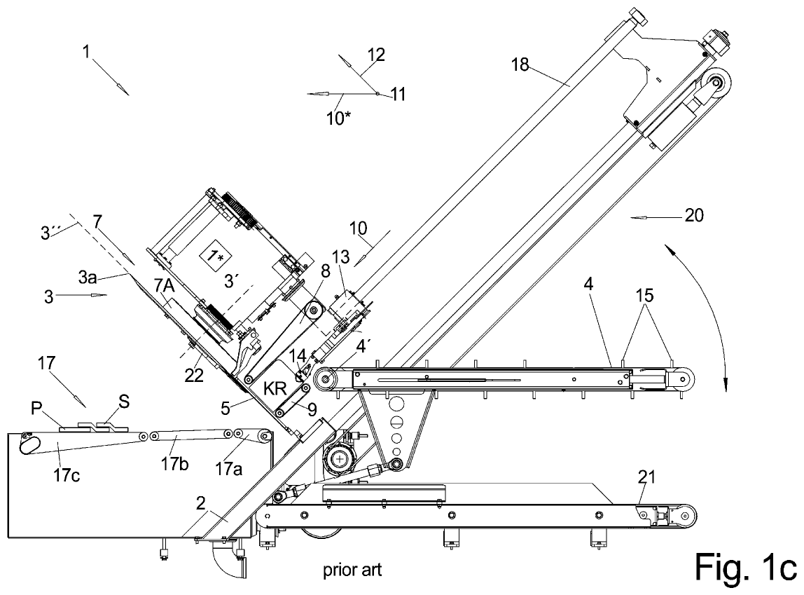

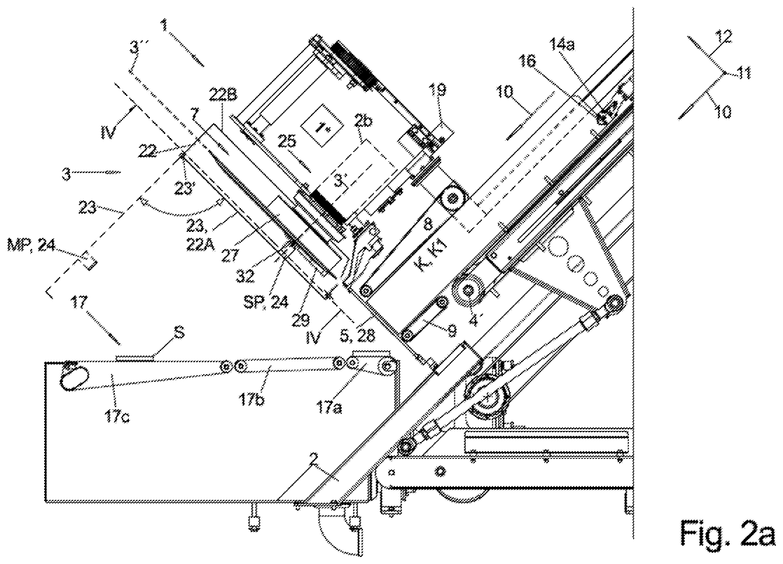

The rear end of each caliber K lying in the feeding unit 20 is held according to FIG. 2a in each case by a gripper 14a-d in a form closure with the aid of gripper claws 16. These grippers 14a-14d, which can be activated and deactivated with regard to the position of the gripper claws 16, are fastened to a common gripper carriage 13, which can be tracked along a gripper guide 18 in the feed direction 10.

In this case, both the feed of the gripper slide 13 and of the feed conveyor 4 can be driven in a controlled manner, wherein, however, the actual feed speed of the logs K is effected by so-called upper and lower product guides 8, 9, which are also driven in a controlled manner and which engage the upper side and lower side of the logs K to be sliced in their front end areas near the cutting unit 7.

The front ends of the calibers K are each extended through a product opening 6a-d of a plate-shaped cutting frame 5, wherein the slicing plane 3″, in which the blade 3 rotates with its slicing edge 3a and thus cuts off the protrusion of the calibers K from the cutting frame 5 as slices S, extends directly in front of the front, downwardly inclined end face of the cutting frame 5. The slicing plane 3″ extends perpendicular to the upper run of the feed conveyor 4 and/or is spanned by the two transverse directions 11, 12 to the feed direction 10.

In this case, the inner circumference of the product openings 6a-d serves as a counter cutting edge of the cutting edge 3a of the blade 3.

Since both product guides 8, 9 can be driven in a controlled manner, particularly independently of one another and/or possibly separately for each track SP1 to SP4, these determine the—continuous or clocked—feed speed of the calibers K through the slicing frame 5.

The upper product guide 8 is displaceable in the second transverse direction 12—which extends perpendicular to the surface of the upper run of the feed conveyor 4—to adapt to the height H of the caliber K in this direction. Further, at least one of the product guides 8, 9 can be designed to pivot about one of its deflection rollers in order to be able to change the direction of the strand of its guide belt resting against the caliber K to a limited extent.

The slices S, which are at an angle in the space when they are separated, fall onto a discharge unit 17, which starts below the cutting frame 5 and extends in the direction of travel 10*, which in this case consists of a plurality of discharge units 17a, b, c arranged one behind the other with their upper runs approximately aligned in the direction of travel 10*, of which the first discharge unit 17a in the direction of travel 10* can be designed as a portioning belt 17a and/or one can also be designed as a weighing unit.

The slices S can hit the discharge unit 17 individually and spaced apart from one another in the direction of travel 10* or, by appropriate control of the portioning belt 17a of the discharge unit 17—whose movement, like almost all moving parts, is controlled by the controller 1*—form shingled or stacked portions P by stepwise forward movement of the portioning belt 17a. In that regard, as one skilled in the art would understand, the controller 1*, as well an any other unit, machine, apparatus, element, sensor (e.g., the below described pivot sensor 32), device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such controller, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

Below the feed conveyor unit 20 there is usually an approximately horizontally extending residue conveyor 21, which starts with its front end below the cutting frame 5 and directly below or behind the discharge unit 17 and with its upper run thereon—by means of the drive of one of the discharge conveyors 17 against the direction of travel 10*—transports away falling residues to the rear.

In FIG. 2a, compared to the representation of FIG. 1c, the known box-shaped protective blade housing 22 enclosing the rotating blade 3 is additionally shown, the front wall 22A of which, facing away from the rotor 27, is designed as an openable protective blade door 23 for access to the blade 3 during mounting and dismounting, in this case hinged to the rest of the protective housing 22 via a pivot axis 23′ extending at the upper end in the transverse direction 11 to the blade axis 3′.

Only in the lower area does the sickle blade 3 protrude once during each rotation through a narrow slot 28 in the narrow wall of the protective blade housing 22, which is directed downwards and backwards, in order to be able to reach the caliber K to be cut open, but this blade slot 28 is generally not large enough to allow the totality of the blade 3 to pass through.

The rotor 27 is normally located within the protective blade housing 22, the back wall 22B of which is tightly penetrated by a shaft between the blade drive 25 (e.g., motor) and the rotor 27.

An inventive element is a catch pivot 24 which, during the slicing operation of the slicing machine 1 on the side of the blade 3 facing away from the blade drive 25, projects with its free end 24E—which the enlargement of FIG. 2b shows better than FIG. 2a—in the direction of the rotor 27 serving as the blade receptacle, that the distance A between the free end 24E of the catch pivot 24 and the free end 27E of the rotor 27 is too small for the blade 3—which generally has a central through-opening 3c concentric with the blade axis 3′—to move out and fly away.

Preferably, the catch pivot 24 protrudes slightly into the central opening 3c for this purpose, i.e. into the thickness area of the blade 3, and the distance A is at least less than the greatest thickness D of the blade, and particularly also greater than the thickness d of the blade 3 around its central opening 3c.

The catch pivot 24 is preferably fastened to the inside of the protective blade door 23, and swivels away with the protective blade door 23 from the slicing position SP into the mounting position MP when the protective blade door 23 is opened, so that the blade 3 can then be easily removed from the rotor 27 by the fitter and removed from the machine 1 when it is swiveled through approximately 90°.

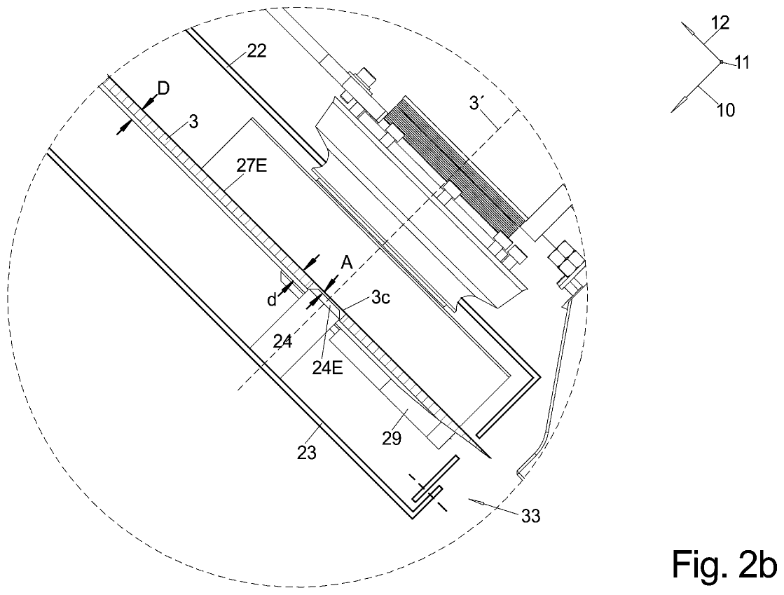

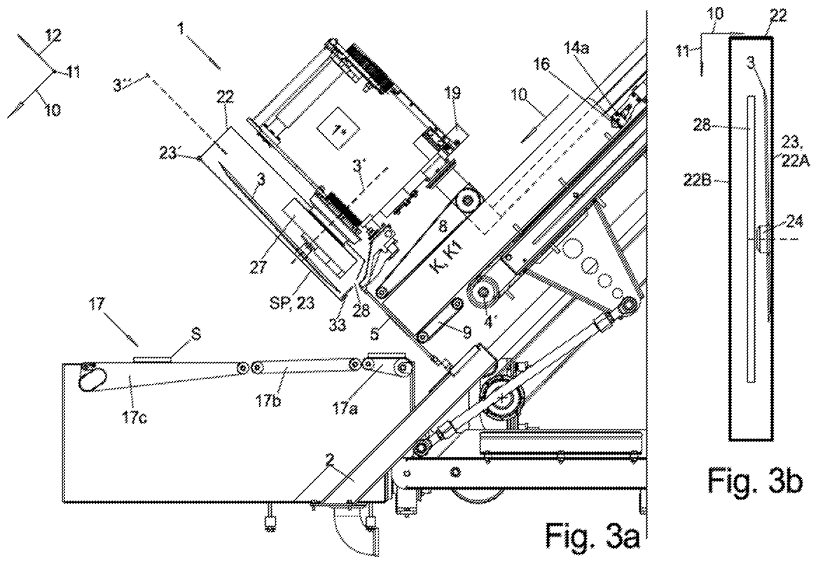

FIG. 3a shows the situation when—with the protective housing 22 closed, i.e. the protective blade door 23 closed—the blade 3 is unintentionally released from the rotor 27 and removed. Then, due to gravity, it will sink further forwards and downwards and continue to thread itself axially around the catch pivot 24 but cannot move away from the catch pivot 24 in a radial direction.

This of course requires that the catch pivot 24 is sufficiently stable and is also sufficiently stably fastened to a component of the environment, in this case to the pivotable protective blade door 23, for which in turn this protective blade door 23 and its fastening to the rest of the protective housing 22, in particular the design of the pivot axis 23′ relative to the protective housing 22, is sufficiently stably designed, and likewise the fastening device 33, with which the movable protective blade door 23 is locked to the rest of the protective housing 22 in the slicing position SP.

FIG. 3b shows the unintentionally detached blade 3 also threaded onto the catch pivot 24, but with a view of the protective blade housing 22 in a separate representation from the side in which the slot 28 for passing through the slicing area of the blade 3 is located in normal slicing operation.

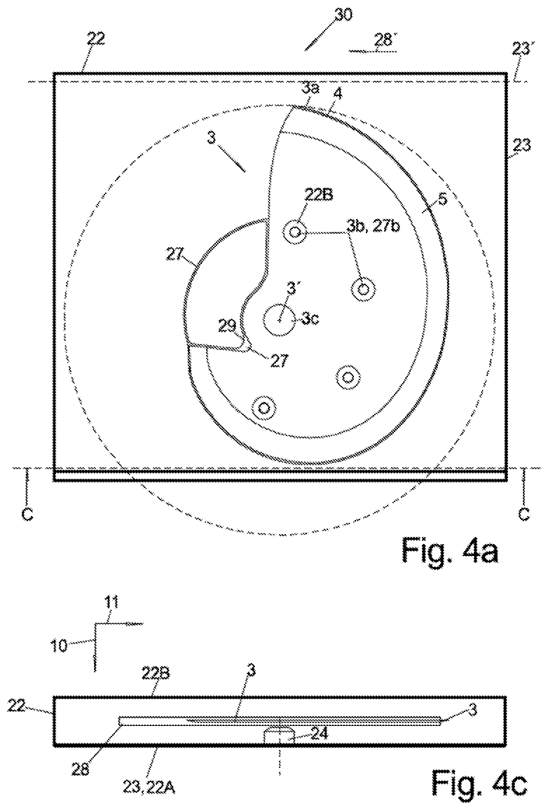

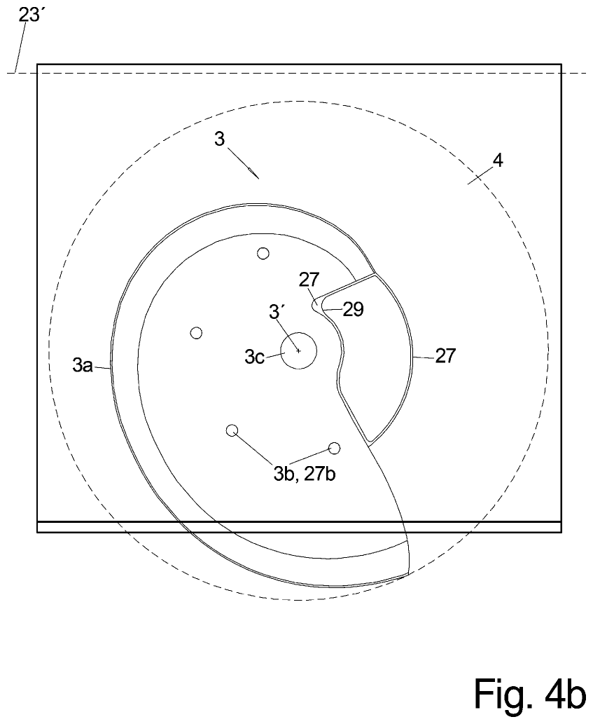

As shown in FIGS. 4a, b looking in the direction of the blade axis 3′, the cube-shaped protective blade housing 22 is dimensioned in such a manner that with each revolution of the sickle blade 3, the slicing area with the greatest distance of its slicing edge 3a from the blade axis 3′ moves out of the protective housing 22 through a blade slot 28 in the narrow side of the protective housing 22 facing downwards towards the rear and separates from the calibers K slices S.

Preferably, the protective housing 22—as shown in FIGS. 4a, b—is dimensioned in such a manner that there are rotational positions of the blade 3 in which the blade 3 is located completely inside the protective housing 22 and does not protrude from it as represented in FIG. 4a.

FIGS. 4a, b also show that the rotor 27 has a round outer circumference, which in some areas is further radially removed from the blade axis 3′, which is also the axis of rotation of the rotor 27, than the outer circumference of the blade 3. In this projection area of the rotor 27, a balancing weight 29 is usually fastened to the rotor 27 or designed to be integrated with the rotor 27, which compensates for the imbalance of the sickle-shaped blade 3.

The balancing weight 29 can also extend in the direction of the blade axis 3′ from the rotor 27 beyond the front side of the blade 3 facing away from the rotor, as can best be seen in FIGS. 2a and 2b, but is no longer represented in FIGS. 4a, b, c.

FIG. 4a further shows the screw openings 3b in the blade 3 away from the central opening 3c around the blade axis 3′, through which the blade 3 is screwed to the rotor 27, and which coincide with the corresponding screw openings or threaded bores 27b of the rotor 27, into which the fastening screws are screwed.

In FIG. 4c—which shows a sectional view in accordance with line C-C of FIG. 4a—the blade slot 28 can be seen, which is slightly wider than the blade 3 is thick, but has a length beyond which the part of the rotating blade 3 located inside partially protrudes in the transverse direction 11, depending on the rotational position of the blade 3.

Preferably, the blade 3 extends beyond the length of the slot 28 in each rotational position in the transverse direction 11, which is an additional safety feature.

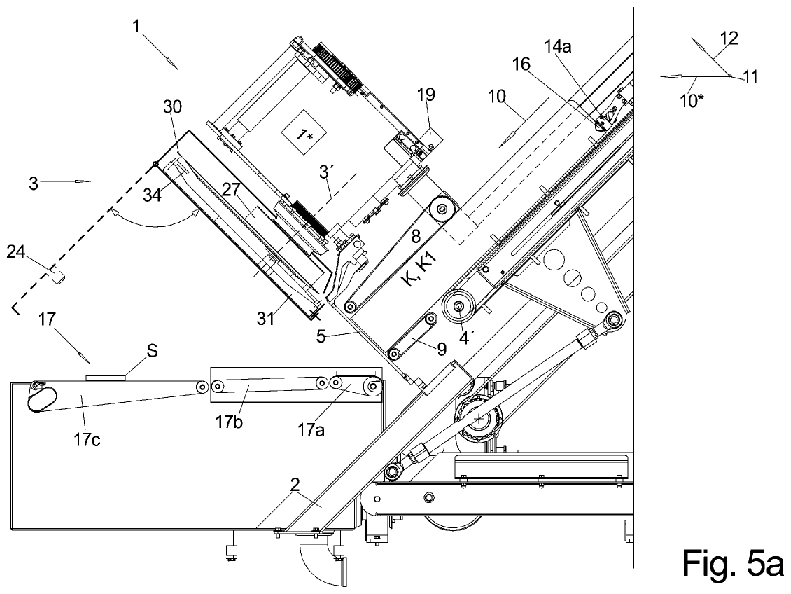

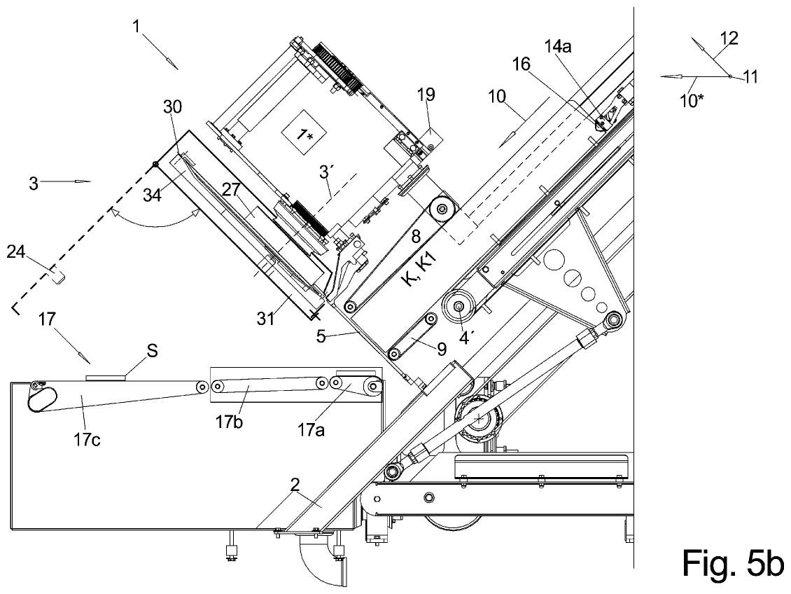

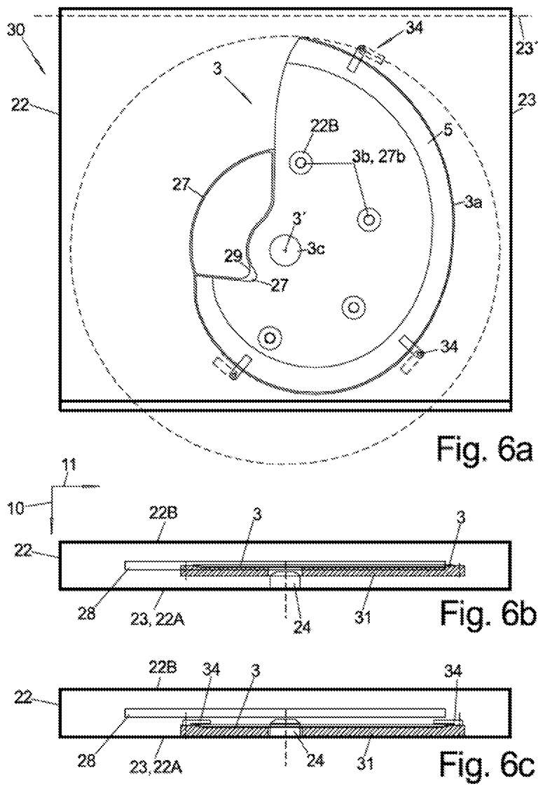

In a view analogous to FIG. 2a, FIGS. 5a, b and FIG. 6a analogous to FIG. 4a additionally show a mounting device 30 in the protective blade housing 22, which facilitates mounting and removal of the blade 3.

This comprises an approximately plate-shaped, but not completely continuous in the plate plane, blade carrier 31, which is arranged on the inside of the protective blade door 23 and can also be fastened, but can preferably also be moved from the attachment on the inside of the protective blade door 23 as a position remote from the rotor—as represented in FIG. 5a—to a position close to the rotor in accordance with FIG. 5b, in which the blade carrier 31 is deposited against the blade 3.

If the blade carrier 31 is fixed and non-detachably fastened to the protective blade door 23, the catch pivot 24 can also be fastened to the blade carrier 31 instead of directly to the protective blade door 23.

If the blade carrier 31 is movable relative to the protective blade door 23 and rotor 27, it has a through-opening around the blade axis 3′, through which the catch pivot 24 fastened to the protective blade door 23 can also extend through the blade carrier 31, as described above, despite fastening to the protective blade door 23.

As best shown in FIG. 6b, if the blade carrier 31 is movable as described, it can be moved into the position close to the rotor to remove the blade 3, preferably until it is attached to the blade 3, and then the blade 3 can be additionally fixed to it by means of at least one fixing device 34 provided on the blade carrier 31, approximately a rotary bolt-see FIG. 6c or FIGS. 5a, b.

Subsequently, the screw connections of the blade 3 can be loosened through the screw openings 3b relative to the rotor 27 and the blade 3 together with the blade carrier 31, to which it is now fastened, can be moved back into the position of the blade carrier 31 remote from the rotor, adjacent to the protective blade door 23, and fixed there.

This release takes place when the protective blade door 23 is closed, with the through-openings not shown.

The protective blade door 23 can then be opened to the mounting position MP and the fitter can then either remove the blade 3 from the blade carrier 31 or remove it from the protective blade housing 22 together with the blade carrier 31, thus minimizing the risk of injury to the fitter.

Mounting a new blade on the rotor 27 is done in reverse order.

FIG. 2a further shows a potential pivot sensor 32, which can be fastened to the free end 27E of the rotor 27, and detects the presence of the free end 24E of the catch pivot 24 at a sufficiently small distance A from the free end 27E of the rotor 27, which is important for the safety function, and signals this to the controller 1*, so that the latter only permits the slicing operation if a corresponding positive signal is present from the pivot sensor 32.

### LIST OF REFERENCE NUMBERS

1 Slicing machine, slicer
1* Controller
2 Base frame
3 Blade
3′ Axis of rotation
3″ Blade plane, slicing plane
3a Slicing edge
3b Screw connection opening
3c Central opening
4 Feed conveyor, feed belt
5 Cutting frame
6a-d Product opening
7 Slicing unit
8 Upper product guide, upper guide belt
8.1 Contact run, lower un
8a Blade-side deflection roller
8b Deflection roller facing away from the blade
9 Lower product guide, lower guide belt
8.1 Contact run, upper run
9a Blade-side deflection roller
9b Deflection roller facing away from the blade
10 Transport direction, longitudinal direction, axial direction
10* Direction of passage through machine
11 1. Transverse direction (width slicer)
12 2. Transverse direction (height-direction of log)
13 Gripper unit, gripper slide
14,14 a-d Gripper
15 Protrusion, spacer
16 Gripper claw
17 Discharge unit
17a, b, c Portioning belt, discharge conveyor
18 Gripper guide
19 Height sensor
20 Feeding unit
21 Residual piece conveyor
22 Protective blade housing
22A Back wall
22B Front wall
22b Through-openings
23 Protective blade door
24 Catch pivot
24E Free end
25 Blade drive
26 Blade motor
27 Rotor, blade receptacle
27b Threaded bores
27E Free end
28 Blade slot
29 Balancing weight
30 Mounting device
31 Blade carrier
32 Pivot sensor
33 fastening device
34 Fixing device
A Distance
D Greatest thickness
d Thickness
K Product, product caliber
KR Remaining piece, caliber rest
MZ Mounting state
SZ Slicing state
S Slice
P Portion

What is claimed is:

1. A slicing machine for slicing product calibers into slices, the slicing machine comprising:
a slicing unit including
a plate-shaped or shell-shaped blade that is drivable in rotation about a blade axis, the blade defining a through-opening,
a blade drive to drive the blade in rotation, the blade drive comprising a rotor as a blade receptacle for the blade, and
a catch pivot positionable between a slicing state for securing the blade and a mounting state allowing the mounting of the blade, wherein, in the slicing state, a free end of the catch pivot is positioned at a distance in front of an oppositely directed free end of the rotor, as viewed in a direction of the blade axis within the through-opening, which is less than a greatest thickness of the blade.

2. The slicing machine according to claim 1, wherein the slicing unit comprises a protective blade housing, which substantially surrounds the blade, a back wall of which is penetrated by the blade drive, and which comprises a movable protective blade door, wherein the catch pivot is present in the protective blade housing.

3. The slicing machine according to claim 2, wherein, in a closed slicing state of the protective blade housing, the catch pivot is positioned in the slicing state.

4. The slicing machine according to claim 1, wherein
the distance is less than a thickness of the blade around the through-opening, and/or
the catch pivot protrudes into the through-opening of the blade.

5. The slicing machine according to claim 1, further comprising a base frame, wherein the catch pivot is detachably fastened to the base frame.

6. The slicing machine according to claim 1, wherein the slicing unit comprises a protective blade housing to receive the blade, the protective blade housing having a movable protective blade door, and wherein
the catch pivot is detachably fastened to an inside of the protective blade housing away from the protective blade door
or
the catch pivot is fastened to an inside of the protective blade door.

7. The slicing machine according to claim 6, wherein the catch pivot is attached to the inside of the protective blade door in such a manner that
after moving the protective blade door into a mounting state, the catch pivot no longer obstructs removal of the blade and/or
after moving the protective blade door into a slicing state, the catch pivot is also in the slicing state securing the blade.

8. The slicing machine according to claim 1 wherein
a largest diameter of the catch pivot is smaller than a smallest diameter of the through-opening of the blade.

9. The slicing machine according to claim 1 wherein
the catch pivot has a circumferential contour without corners.

10. The slicing machine according to claim 9, wherein the circumferential contour is round or elliptical.

11. The slicing machine according to claim 1 wherein
the catch pivot is centered on the blade axis,
or
a balancing weight projects from the rotor into the through-opening, which is arranged eccentrically to the blade axis, and the catch pivot is arranged with its free end away from the balancing weight.

12. The slicing machine according to claim 1, wherein
the catch pivot tapers conically towards the free end,
and/or
the rotor has in its free end a recess into which the catch pivot projects with its free end without contact.

13. The slicing machine according to claim 1, wherein
a largest diameter of the catch pivot is at most 30% smaller than a smallest inside diameter of the through-opening.

14. The slicing machine according to claim 1, further comprising a pivot sensor configured to detect presence of the catch pivot in the slicing state.

15. The slicing machine according to claim 1, wherein the slicing unit comprises a protective blade housing to receive the blade, the protective blade housing defines a blade slot, and a length of the blade slot is less than a smallest transverse width of the blade measured in blade plane of the blade.

16. The slicing machine according to claim 1, wherein
the slicing unit comprises a protective blade housing to receive the blade,
a front wall of the protective blade housing has through-openings at positions of screw connection openings for the blade in the rotor as viewed in the direction of the blade axis,
a blade carrier is fastened to an inside of the front wall of the protective blade housing.

17. The slicing machine according to claim 16, wherein
the blade carrier protrudes radially beyond the blade,
the blade carrier can be moved back and forth in the direction of the blade axis between a first position close to the rotor and a second position remote from the rotor.

18. The slicing machine according to claim 17, wherein the blade carrier can be fixed in the first and second positions from outside the protective blade housing.

19. A method for operating a slicing machine, which has a blade that is rotatable about a blade axis and fastened to a rotor configured to rotate the blade, the method comprising:
in a slicing operation, arranging a catch pivot extending in a direction of the blade axis with its free end at a distance in front of an oppositely directed free end of the rotor which is less than a thickness of the blade, and
arranging the blade at least partially in a protective blade housing during the slicing operation.

20. The method according to claim 19, further comprising mounting or dismounting the blade on the slicing machine,
wherein for dismounting the blade with the blade stationary
blade screw connections opposite the rotor are loosened and the blade is removed from the rotor,
the blade is received in the blade carrier,
the blade is fastened to the blade carrier,
then a protective blade door of the protective blade housing is opened, the blade carrier with the blade is removed from the slicing machine, and/or
wherein for mounting the blade
a blade carrier with a blade attached to the blade carrier is inserted into the protective blade housing with the protective blade door open,
fastening of the blade to the blade carrier is loosened,
the protective blade door is closed,
the blade is fastened to the rotor.
